(19) United States
(12) Patent Application Publication
(10) Pub. No.: US 2024/0005562 A1
(43) Pub. Date: Jan. 4, 2024

(54) POINT CLOUD ENCODING METHOD AND APPARATUS, ELECTRONIC DEVICE, MEDIUM AND PROGRAM PRODUCT

(71) Applicant: PEKING UNIVERSITY SHENZHEN GRADUATE SCHOOL, Shenzhen (CN)

(72) Inventors: Ge LI, Shenzhen (CN); Fei SONG, Shenzhen (CN)

(21) Appl. No.: 18/252,395

(22) PCT Filed: Nov. 8, 2021
(86) PCT No.: PCT/CN2021/129264

§ 371 Date: May 10, 2023

(30) Foreign Application Priority Data
Sep. 27, 2021 (CN) 202111138592.X

(51) Int. Cl. G06T 9/00; G06T 9/40

(52) U.S. Cl. CPC G06T 9/001; G06T 9/40

(57) ABSTRACT

Disclosed are a point cloud encoding method and apparatus, an electronic device, a medium, and a program product. The method includes: performing image layer division on a to-be-processed laser radar point cloud to generate different types of image layers; performing region segmentation on each image layer using a region segmentation method correspondingly set for a type of the corresponding image layer, so as to obtain region images corresponding to each image layer; arranging the region images corresponding to each image layer to obtain arranged images corresponding to each image layer; and encoding each arranged image based on an encoding method correspondingly set for the type of the corresponding arranged image, so as to obtain encoded data of the laser radar point cloud.

### CROSS-REFERENCE TO RELATED APPLICATIONS

The present application claims priority to Chinese Patent Application No. 202111138592.X, entitled “Point Cloud Encoding Method and Apparatus, Electronic Device, Medium and Program Product”, filed with China National Intellectual Property Administration on Sep. 27, 2021, the entire content of which is incorporated herein by reference.

### TECHNICAL FIELD

The present application relates to the field of point cloud processing technologies, and particularly to a point cloud encoding method and apparatus, an electronic device, a medium, and a program product.

### BACKGROUND ART

A point cloud is obtained by sampling a surface of an object using a three-dimensional scanning device, and a number of points of one point cloud frame is generally in a million level, wherein each point contains attribute information, such as geometric information, color, reflectivity, or the like. Therefore, the three-dimensional point cloud has a huge data quantity, which brings huge challenges to storage, transmission, or the like, of the three-dimensional point cloud, such that compression of point cloud is quite necessary.

Currently, technicians usually encode point cloud data using a progressive octree, a prediction tree, dynamic binary decomposition, shape-adaptive wavelet transform, graph transformation and other methods.

However, the above encoding methods can have a better compression performance during encoding of point cloud data with strong correlation between points, and if there are many discontinuous regions in the point cloud (for example, a laser radar point cloud), the correlation between points in the point cloud data is weak, and the above encoding methods will generate more redundancy and have a poor compression performance during encoding of such point cloud data.

In order to improve the compression performance when the laser radar point cloud is encoded, related technicians try to divide the laser radar point cloud into different local regions and encode the point cloud using various geometric models. Such a method can really achieve a better compression performance, but the method cannot realize lossless encoding due to filtering of abnormal points and a floating point operation.

Therefore, how to improve the compression performance when lossless encoding is performed on the laser radar point cloud is a problem to be solved.

### SUMMARY

Embodiments of the present application provide a point cloud encoding method and apparatus, an electronic device, a medium and a program product, which are used for improving a compression performance when lossless encoding is performed on a laser radar point cloud.

Some embodiments of the present application provide a point cloud encoding method, which may include steps of:
performing image layer division on a to-be-processed laser radar point cloud to generate different types of image layers;
performing region segmentation on each image layer using a region segmentation method correspondingly set for a type of the corresponding image layer, so as to obtain region images corresponding to each image layer;
arranging the region images corresponding to each image layer to obtain arranged images corresponding to each image layer, such that every two adjacent region images in the arranged images have a connection point, wherein the type of each image layer is the same as that of the corresponding arranged images; and
encoding each arranged image based on an encoding method correspondingly set for the type of the corresponding arranged image, so as to obtain encoded data of the laser radar point cloud.

In the above implementation process, image layer division is performed on the laser radar point cloud to determine the different types of image layers, thus facilitating further determining region segmentation according to the type of each image layer. Region segmentation is performed on the corresponding image layer according to the region segmentation corresponding to each type, so as to obtain the region images of each image layer, thus facilitating arranging the region images of each image layer, thereby reducing an occupied space of the region images and a redundancy of image data storage. Further, each arranged image is encoded based on the encoding method correspondingly set for the type of the corresponding arranged image, thereby realizing lossless encoding of the laser radar point cloud, and improving the compression performance during encoding of the laser radar point cloud.

In an embodiment, the types of the image layers may include: a noise type, a ground type and an object type. The step of performing image layer division on a to-be-processed laser radar point cloud to generate different types of image layers includes steps of:
performing image layer division on the laser radar point cloud by filtering, so as to obtain an image layer of a noise type and an image layer of a non-noise type; and
performing image layer division on the mage layer of the non-noise type by ground extraction, so as to obtain an it mage layer of a ground type and an image layer of an object type.

In the above implementation process, the image layer division is performed on the laser radar point cloud by filtering, so as to obtain the image layer of the noise type and the image layer of the non-noise type. Further, the image layer division is performed on the image layer of the non-noise type by ground extraction, so as to obtain the image layer of the ground type and the image layer of the object type, so that a layered processing of the point clouds with different characteristics in the laser radar point cloud is realized.

In an embodiment, the step of performing region segmentation on each image layer using a region segmentation method correspondingly set for a type of the corresponding image layer, so as to obtain region images corresponding to each image layer may include steps of:
performing object segmentation on the image layer of the object type to obtain object region images of an object type;
performing ground segmentation on the image layer of the ground type to obtain ground region images of a ground type; and
performing noise segmentation on the image layer of the noise type to obtain noise regions image of a noise type.

In the above implementation process, region segmentation is performed on the image layer of each type to obtain the region images corresponding to each image layer, thus facilitating arranging adjacently the region images of each image layer.

In an embodiment, the step of performing object segmentation on the image layer of the object type to obtain each object region image of an object type may include steps of:
performing coordinate system conversion on each coordinate point in the image layer of the object type based on a coordinate system of the image layer of the object type and a reference coordinate system, so as to obtain a mapped object image of the image layer of the object type in the reference coordinate system;
performing object segmentation on the mapped object image to obtain segmented object region images;
matching the object region images with objects in the image layer of the object type respectively;
screening out an object characterized by successfully matched according to the matching result from the objects in the image layer of the object type; and
segmenting object region images corresponding to the screened object from the image layer of the object type.

In the above implementation process, the region segmentation is performed on the image layer of the object type to obtain object region images, such that objects in the image layer of the object type are segmented as independent region images, which further provides a basis for the subsequent arrangement of the region images of the object type.

In an embodiment, the step of performing ground segmentation on the image layer of the ground type to obtain each ground region image of a ground type may include steps of:
performing coordinate conversion on each coordinate point in the image layer of the ground type based on a coordinate system of the image layer of the ground type and the reference coordinate system, so as to obtain elevation angle data of each coordinate in the image layer of the ground type in the reference coordinate system; and
performing Gaussian fitting on the elevation angle data of each of the coordinate points to obtain the ground region images of the ground type.

In the above implementation process, the ground region images of the image layer of the ground type are generated by Gaussian fitting, such that the ground region images of the image layer of the ground type are segmented as independent region images, which further provide a basis for the subsequent arrangement of the region images of the ground type.

In an embodiment, the step of performing coordinate system conversion on each coordinate point in the image layer of the object type based on a coordinate system of the image layer of the object type and a reference coordinate system, so as to obtain a mapped object image of the image layer of the object type in the reference coordinate system may include a step of:
mapping each coordinate point in the coordinate system of the image layer of the object type into the reference coordinate system using a preset resolution, so as to obtain the mapped object image of the image layer of the object type in the reference coordinate system.

In an embodiment, the step of performing noise segmentation on the image layer of the noise type to obtain noise region images of a noise type may include a step of:
performing noise segmentation on noises in the image layer of the noise type to obtain each noise region image of the noise type.

In the above implementation process, noises in the image layer of the noise type are segmented into respective noise region images, such that the noise region images are segmented as independent units, which further provides a basis for the subsequent arrangement of the region images of the noise type.

In an embodiment, the step of arranging the region images corresponding to each image layer to obtain arranged images corresponding to each image layer may include steps of:
arranging the object region images to obtain arranged images of an object type;
arranging the ground region images to obtain arranged images of a ground type; and
arranging the noise region images to obtain arranged images of a noise type.

In the above implementation process, the region images of each type are arranged, such that every two adjacent region images in the arranged images have a connection point, and therefore, the region images are aggregated to reduce the occupied space of the images and thus reduce the data storage redundancy.

In an embodiment, the step of encoding each arranged image based on an encoding method correspondingly set for the type of the corresponding arranged image, so as to obtain encoded data of the laser radar point cloud may include steps of:
encoding the arranged images of the noise type using binary differential encoding set for the arranged images of the noise type, so as to obtain encoded data of the image layer of the noise type;
encoding the arranged images of the object type using octree encoding set for the arranged images of the object type, so as to obtain encoded data of the image layer of the object type;
encoding the arranged images of the ground type using Gaussian differential encoding set for the arranged images of the ground type, so as to obtain encoded data of the image layer of the ground type; and
obtaining the encoded data of the laser radar point cloud based on the encoded data of the image layer of the noise type, the encoded data of the image layer of the object type and the encoded data of the image layer of the ground type.

In the above implementation process, the arranged images of each type are encoded using the encoding method correspondingly set for the type of the arranged images to obtain the encoded data of the image layer of each type, such that the image layer of each type forms a data stream, thus facilitating data transmission.

Some other embodiments of the present application provide a point cloud encoding apparatus, which may include:
an image layer division unit, configured to perform image layer division on a to-be-processed laser radar point cloud to generate different types of image layers;
a region segmentation unit, configured to perform region segmentation on each image layer using a region segmentation method correspondingly set for a type of the corresponding image layer, so as to obtain region images corresponding to each image layer;
an arranging unit, configured to arrange the region images corresponding to each image layer to obtain arranged images corresponding to each image layer, such that every two adjacent region images in the arranged images have a connection point, wherein the type of each image layer is the same as that of the corresponding arranged images; and
an encoding unit, configured to encode each arranged image based on an encoding method correspondingly set for the type of the corresponding arranged image, so as to obtain encoded data of the laser radar point cloud.

In an embodiment, the types of the image layers may include: a noise type, a ground type and an object type; the image layer division unit may be specifically configured to:
perform image layer division on the laser radar point cloud by filtering, so as to obtain an image layer of a noise type and an image layer of a non-noise type; and
perform image layer division on the image layer of the non-noise type by ground extraction, so as to obtain an image layer of a ground type and an image layer of an object type.

In an embodiment, the region segmentation unit may be specifically configured to:
perform object segmentation on the image layer of the object type to obtain object region images of an object type;
perform ground segmentation on the image layer of the ground type to obtain ground region images of a ground type; and
perform noise segmentation on the image layer of the noise type to obtain noise region images of a noise type.

In an embodiment, the region segmentation unit may be specifically configured to:
perform coordinate system conversion on each coordinate point in the image layer of the object type based on a coordinate system of the image layer of the object type and a reference coordinate system, so as to obtain a mapped object image of the image layer of the object type in the reference coordinate system;
perform object segmentation on the mapped object image to obtain segmented object region images;
match the object region images with objects in the image layer of the object type respectively;
screen out an object characterized by successfully matched according to the matching result from the objects in the image layer of the object type; and
segment object region images corresponding to the screened object from the image layer of the object type.

In an embodiment, the region segmentation unit may be specifically configured to:
perform coordinate conversion on each coordinate point in the image layer of the ground type based on a coordinate system of the image layer of the ground type and the reference coordinate system, so as to obtain elevation angle data of each coordinate in the image layer of the ground type in the reference coordinate system; and
perform Gaussian fitting on the elevation angle data of each of the coordinate points to obtain the ground region images of the ground type.

In an embodiment, the region segmentation unit may be specifically configured to:
perform noise segmentation on noises in the image layer of the noise type to obtain each noise region image of the noise type.

In an embodiment, the arranging unit may be specifically configured to:
arrange the object region images to obtain arranged images of an object type;
arrange the ground region images to obtain arranged images of a ground type; and
arrange the noise region images to obtain arranged images of a noise type.

In an embodiment, the encoding unit may be specifically configured to:
encode the arranged images of the noise type using binary differential encoding set for the arranged images of the noise type, so as to obtain encoded data of the image layer of the noise type;
encode the arranged images of the object type using octree encoding set for the arranged images of the object type, so as to obtain encoded data of the image layer of the object type;
encode the arranged images of the ground type using Gaussian differential encoding set for the arranged images of the ground type, so as to obtain encoded data of the image layer of the ground type; and
obtain the encoded data of the laser radar point cloud based on the encoded data of the image layer of the noise type, the encoded data of the image layer of the object type and the encoded data of the image layer of the ground type.

Further embodiments of the present application provide an electronic device, which may include:
a processor, a memory and a bus, wherein the processor is connected with the memory through the bus, and the memory stores computer-readable instructions which are used for implementing the steps in the method according to any one of the above embodiments when executed by the processor.

Still further embodiments of the present application provide a computer-readable storage medium, having a computer program stored thereon, wherein the computer program, when executed by a processor, may implement the steps in the method according to any one of the above embodiments.

Other embodiments of the present application provide a computer program product which, when run on a computer, may cause the computer to perform the method according to any one of the above embodiments.

In order to make the above mentioned objects, features, and advantages to be achieved by the embodiments of the present application more apparent, preferred embodiments are described in detail hereinafter by referring to the accompanying drawings.

### BRIEF DESCRIPTION OF DRAWINGS

To describe the technical solutions in the embodiments of the present application more clearly, the following briefly describes the accompanying drawings required in the embodiments of the present application. It should be understood that the following accompanying drawings show merely some embodiments of the present application and therefore should not be considered as limiting the scope, and a person of ordinary skill in the art may still derive other related drawings from these accompanying drawings without creative efforts.

FIG. 1 is a flow chart of a point cloud encoding method according to an embodiment of the present application;

FIG. 2 is a schematic diagram of a laser radar point cloud in an embodiment of the present application;

FIG. 3 is a schematic diagram of an image layer of a noise type in an embodiment of the present application;

FIG. 4 is a schematic diagram of an image layer of a ground type in an embodiment of the present application;

FIG. 5 is a schematic diagram of an image layer of an object type in an embodiment of the present application;

FIG. 6 is a schematic diagram of region segmentation performed on the image layer of the object type in an embodiment of the present application;

FIG. 7 is a schematic diagram of bounding boxes of objects in an embodiment of the present application;

FIG. 8 is a schematic diagram of arranged images of an object type in an embodiment of the present application;

FIG. 9 is a comparison diagram of an encoding result in an embodiment of the present application;

FIG. 10 is a schematic structural diagram of a point cloud encoding apparatus according to an embodiment of the present application; and

FIG. 11 is a schematic structural diagram of an electronic device according to an embodiment of the present application.

### DETAILED DESCRIPTION

The technical solutions in the embodiments of the present application are clearly and completely described with reference to the accompanying drawings in the embodiments of the present application, and apparently, the described embodiments are not all but only a part of the embodiments of the present application. Generally, the components of the embodiments of the present application described and illustrated in the drawings herein may be arranged and designed in a variety of different configurations. Accordingly, the following detailed description of the embodiments of the present application provided in the drawings is not intended to limit the scope of protection of the present application, but only represents selected embodiments of the present application. All other embodiments obtained by those skilled in the art based on the embodiments of the present application without creative efforts shall fall within the protection scope of the present application.

It should be noted that similar reference signs and letters denote similar items in the following drawings. Therefore, once a certain item is defined in one figure, it does not need to be further defined and explained in the subsequent figures. Meanwhile, in the description of the present application, the terms such as “first”, “second”, or the like, are only used for distinguishing descriptions and are not intended to indicate or imply relative importance.

Some terms referred to in the embodiments of the present application will be described first to facilitate understanding by those skilled in the art.

Terminal device: it may be a mobile terminal, a fixed terminal, or a portable terminal, such as a mobile phone, a site, a unit, a device, a multimedia computer, a multimedia tablet, an Internet node, a communicator, a desktop computer, a laptop computer, a notebook computer, a netbook computer, a tablet computer, a personal communication system device, a personal navigation device, a personal digital assistant, an audio/video player, a digital camera/camcorder, a positioning device, a television receiver, a radio broadcast receiver, an electronic book device, a gaming device, or any combination thereof, including accessories and peripherals of these devices, or any combination thereof. It is also contemplated that the terminal device can support any type of user interface (for example, a wearable device), or the like.

Server: it may be an independent physical server, a server cluster or a distributed system formed by a plurality of physical servers, or a cloud server for providing a cloud service, a cloud database, cloud computing, a cloud function, a cloud storage, a network service, a cloud communication, a middleware service, a domain name service, a security service, and a basic cloud computing service, such as big data, an artificial intelligence platform, or the like.

A three-dimensional point cloud is an important representation of real world digitization. With a rapid development of a three-dimensional scanning device, precision and a resolution of the obtained point cloud are continuously improved. The high-precision point cloud is widely applied to construction of urban digital maps, and for example, it serves as technical supports in a plurality of popular researches, such as smart city, unmanned driving, cultural relic preservation, or the like. A point cloud is an image obtained by scanning a surface of an object using a three-dimensional scanning device, a number of points of one point cloud frame is generally in a million level, wherein each point contains attribute information, such as geometric information, color, reflectivity, or the like, and the data quantity is huge. The huge data quantity of the three-dimensional point cloud brings huge challenges to data storage, transmission, or the like, such that compression of point cloud is quite necessary.

Currently, technicians usually encode point cloud data using a progressive octree, a prediction tree, a dynamic binary decomposition, a shape-adaptive wavelet transform, a graph transformation and other methods.

However, the above encoding methods can have a better compression performance during encoding of point cloud data with strong correlation between points, and if there are many discontinuous regions in the point cloud (for example, a laser radar point cloud), the correlation between points in the point cloud data is weak, and the above encoding methods will generate more redundancy and have a poor compression performance during encoding of such point cloud data.

In order to improve the compression performance when the laser radar point cloud is encoded, related technicians try to divide the laser radar point cloud into different local regions and encode the point cloud using various geometric models. Such a method can really achieve a better compression performance, but the method cannot realize lossless encoding due to filtering of abnormal points and a floating point operation.

Thus, the present application provides a point cloud encoding method and apparatus, an electronic device, a medium and a program product, which are used for improving a compression performance when lossless encoding is performed on a laser radar point cloud.

In the embodiments of the present application, a subject for executing the method may be an electronic device, and optionally, the electronic device may be a server or a terminal device, but the present application is not limited thereto.

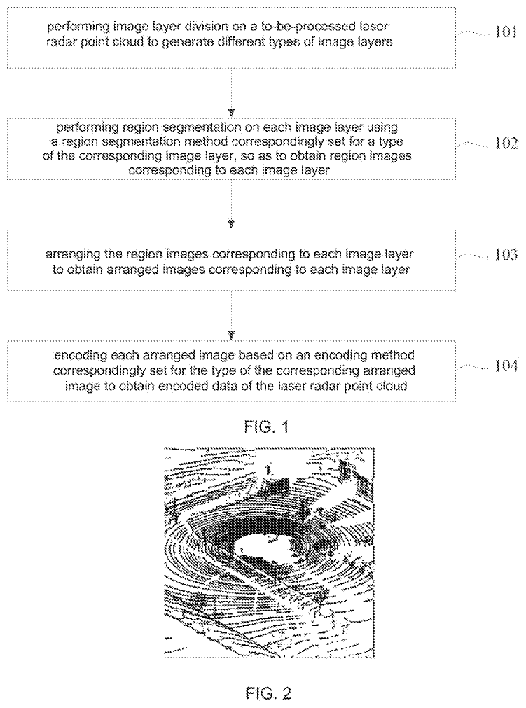

Reference is made to FIG. 1 which is a flow chart of a point cloud encoding method according to an embodiment of the present application, and the method shown in FIG. 1 specifically includes:
step 101: performing image layer division on a to-be-processed laser radar point cloud to generate different types of image layers.

Specifically, the types of the image layers may include: a noise type, a ground type and an object type, and following steps may be implemented when step 101 is performed:
S1011: performing image layer division on the laser radar point cloud by filtering, so as to obtain an image layer of a noise type and an image layer of a non-noise type.

Specifically, the to-be-processed laser radar point cloud is filtered using a filtering algorithm, so as to generate the image layer of the noise type and the image layer of the non-noise type.

As an embodiment, the to-be-processed laser radar point cloud is a point cloud generated by scanning a surrounding environment with a laser radar in an automatic driving scenario.

As an embodiment, the to-be-processed laser radar point cloud is filtered using a radius outlier removal filter (RORF) algorithm to generate the image layer of the noise type and the image layer of the non-noise type.

It should be noted that, in the embodiment of the present application, as an example for description, the RORF algorithm is taken as the filtering algorithm, and in practical applications, the filtering algorithm may be a conditional filtering algorithm or a domain filtering algorithm, which is not limited herein.
S1012: performing image layer division on the image layer of the non-noise type by ground extraction, so as to obtain an image layer of a ground type and an image layer of an object type.

Specifically, ground extraction may be performed on the image layer of the non-noise type using a fitting algorithm, so as to generate the image layer of the ground type and the image layer of the object type.

As an embodiment, ground extraction may be performed on the image layer of the non-noise type using an M-estimator sample consensus (MSAC) algorithm.

Specifically, in a hypothesis stage, in the MSAC, a small part of points are extracted from the image layer of the non-noise type as a subset using a strategy of a random sample consensus algorithm, and then, parameters of a ground model are estimated based on the extracted subset, wherein the ground model may be defined as:

ax+by+cz+d=0 (1)
wherein a, b, c and d are the parameters of the ground model to be estimated respectively, and x, y and z are coordinates of the point in the subset.

During hypothesis, in the MSAC, a plurality of planes of the ground model may be generated.

During verification, the points left in the point cloud are used to determine the most appropriate hypothesis. Typically, a cost function is used to evaluate the hypothesis, and can be defined as:

C₂=Σᵢρ₂(eᵢ²) (2)
wherein eᵢ represents an error of an ith observation, and the robust error term ρ₂ is calculated as follows:

$${ρ}_{2} ( {e}^{2} ) = \{ \begin{matrix}{e}^{2} , & {e}^{2} < {H}^{2} \\ {H}^{2} , & {e}^{2} \geq {H}^{2}\end{matrix} \qquad ( 3 )$$

wherein H is an error threshold.

The hypothesis of a numeral value with a smallest cost can be selected by H.

Optionally, the image layer of the ground type may be generated by fitting the ground.

Optionally, after around extraction is performed on the image layer of the non-noise type, the remaining part of the point cloud may be used as the image layer of the object type.

It should be noted that, in the present application, as an example for description, the MSAC algorithm is taken as the fitting algorithm, and in practical applications, the fitting algorithm may be a least median method or a random sample consensus algorithm, which is not limited herein.

As shown in FIG. 2 which is a schematic diagram of a laser radar point cloud in the embodiment of the present application, image layer division is performed on the laser radar point cloud of FIG. 2 by filtering, so as to obtain the image layer of the noise type and the image layer of the non-noise type. In the embodiment of the present application, the laser radar point cloud is described only by an image formed by points in FIG. 2, and if there are unclear points in FIG. 2, the clarity of the specification of the present application will not be affected.

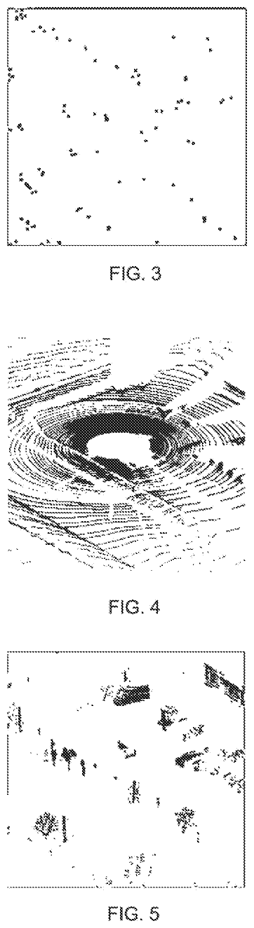

Referring to FIG. 3 which is a schematic diagram of an image layer of a noise type in the embodiment of the present application, a black point in FIG. 3 represents a noise in the image layer of the noise type. In the embodiment of the present application, the noise in the image layer of the noise type is described only by the black point in FIG. 3, and if there are unclear black points in FIG. 3, the clarity of the specification of the present application will not be affected.

Referring to FIG. 4 which is a schematic diagram of an image layer of a ground type in the embodiment of the present application and FIG. 5 which is a schematic diagram of an image layer of an object type in the embodiment of the present application, image layer division is performed on the non-noise image layer, so as to obtain the image layer of the ground type shown in FIG. 4 and the image layer of the object type shown in FIG. 5. In the embodiment of the present application, the ground in the image layer of the ground type is illustrated only by the curved line in FIG. 4, and if there is unclear curved lines in FIG. 4, the clarity of the specification of the present application will not be affected. Similarly, an object in the image layer of the object type is illustrated only by the object in FIG. 5, and if there are unclear objects in FIG. 5, the clarity of the specification of the present application will not be affected.

In the above implementation process, image layer division may be performed on the laser radar point cloud by filtering, so as to obtain the image layer of the noise type and the image layer of the non-noise type; further, image layer division may be performed on the image layer of the non-noise type by ground extraction, so as to obtain the image layer of the ground type and the image layer of the object type, thereby realizing layered processing of point clouds with different characteristics in the laser radar point cloud.

Step 102: performing region segmentation on each image layer using a region segmentation method correspondingly set for a type of the corresponding image layer, so as to obtain region images corresponding to each image layer.

Specifically, object segmentation is performed on the image layer of the object type based on a mapped segmentation algorithm, so as to obtain object region images of an object type, wherein each object region image is an independent unit.

Specifically, following steps may be implemented when step 102 is performed:
S1021: performing object segmentation on the image layer of the object type to obtain object region images of an object type.

Specifically, following steps may be implemented when S1021 is performed:
S1021a: performing coordinate system conversion on each coordinate point in the image layer of the object type based on a coordinate system of the image layer of the object type and a reference coordinate system, so as to obtain a mapped object image of the image layer of the object type in the reference coordinate system.

Specifically, each coordinate point in the coordinate system of the image layer of the object type is mapped into the reference coordinate system using a preset resolution, so as to obtain the mapped object image of the image layer of the object type in the reference coordinate system.
S1021b: performing object segmentation on the mapped object image to obtain segmented object region images.

Object segmentation can be performed on the mapped object image based on a robust segmentation algorithm to obtain the segmented object images.
S1021c: matching the object region images with objects in the image layer of the object type respectively.

The segmented object region images may be matched with objects in the image layer of the object type respectively to obtain matching results, wherein the matching results may include successful matching and unsuccessful matching.

In the above, points which are not successfully matched can be separated from the image layer of the object type, and the unmatched points may be transferred to the image layer of the noise type.
S1021d: screening out an object characterized by successfully matched according to the matching result from the objects in the image layer of the object type.

Specifically, the object characterized by successfully matched is screened out according to the successfully matching result from the objects in the image layer of the object type.
S1021e: segmenting object region images corresponding to the screened object from the image layer of the object type.

Specifically, in the image layer of the object type, the object region images corresponding to the successfully matched object are segmented.

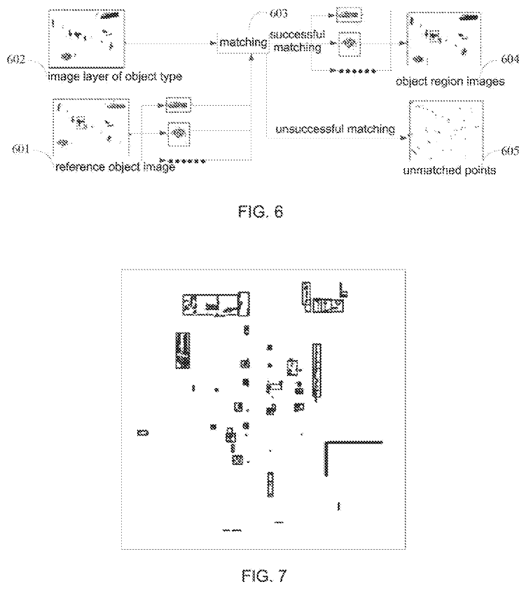

As an embodiment, FIG. 6 is a schematic diagram of region segmentation performed on the image layer of the object type in the embodiment of the present application. As shown in FIG. 6, each coordinate point in the image layer of the object type is mapped into the reference coordinate system to obtain a reference object image 601 in the reference coordinate system. The reference object image 601 may be subjected to object segmentation to obtain respective segmented object images, the segmented object images are matched 603 with the objects in the image layer of the object type. If matching is successful, object region images 604 of the image layer of the object type are obtained, and if matching is unsuccessful, unmatched points 605 are obtained, and the unmatched points are further transferred to the image layer of the noise type.

In the above implementation process, region segmentation may be performed on the image layer of the object type to obtain object region images, such that objects in the image layer of the object type are divided into independent region images, which further provides a basis for the subsequent arrangement of the region images.
S1022: performing ground segmentation on the image layer of the ground type to obtain ground region images of a ground type.

Ground segmentation is performed on the image layer of the ground type using a Gaussian mixture model to obtain ground region images of the ground type.

Specifically, following steps may be implemented when S1022 is performed:
S1032a: performing coordinate conversion on each coordinate point in the image layer of the ground type based on a coordinate system of the image layer of the ground type and the reference coordinate system, so as to obtain elevation angle data of each coordinate in the image layer of the ground type in the reference coordinate system.

As an embodiment, a coordinate point (x, y, z) in the image layer of the ground type is converted to a corresponding point (θ, φ, z) in the reference coordinate system, wherein θ is elevation angle data for the coordinate point.

Specifically, the coordinate point (θ, φ, z) in the reference coordinate system and the coordinate point (x, y, z) in the image layer of the ground type may be converted by the following expressions:

$$φ = arccos \frac{x}{\sqrt{{x}^{2} + {y}^{2}}} \qquad ( 4 )$$

$$θ = arcsin \frac{z}{\sqrt{{x}^{2} + {y}^{2} + {z}^{2}}} \qquad ( 5 )$$

S1032b: performing Gaussian fitting on the elevation angle data of each of the coordinate points to obtain the ground region images of the ground type.

The elevation angle data of each of the coordinate points in the reference coordinate system can be subjected to Gaussian fitting to obtain a plurality of Gaussian density functions, wherein an image corresponding to each Gaussian density function is a ground region image.

As an embodiment, the ground region images of the image layer of the ground type are obtained according to the images corresponding to respective Gaussian density functions.

In the above implementation process, the ground region images of the image layer of the ground type may be generated by Gaussian fitting, such that the ground region images of the image layer of the ground type are segmented as independent region images, which provides a basis for the subsequent arrangement of the region images of the ground type.
S1023: performing noise segmentation on the image layer of the noise type to obtain noise region images of a noise type.

Specifically, any of the following manners may be implemented when S1023 is performed:
first manner: performing region division on the original image layer of the noise type to obtain a set of region images of a noise type.
Second manner: performing region division on the image layer of the noise type after the unmatched points in the image layer of the object type are transferred to the original image layer of the noise type, so as to obtain a set of region images of a noise type.

Specifically, in the present application, region division for the image layer of the noise type in the second manner is taken as an example for description. When the second manner is executed, noise segmentation may be performed on the noises in the image layer of the noise type to obtain noise region images of the noise type.

As an embodiment, the noises in the image layer of the noise type can be divided into the noise region images, wherein the noise region images are independent units.

In the above implementation process, noises in the image layer of the noise type may be divided into respective noise region images, such that noise region images are divided into independent units, which further provides a basis for the subsequent arrangement of the region images.

Step 103: arranging the region images corresponding to each image layer to obtain arranged images corresponding to each image layer.

Therefore, every two adjacent region images in the arranged images may have a connection point, wherein the type of each image layer is the same as that of the corresponding arranged images.

Specifically, following steps may be implemented when step 103 is performed:
S1031: arranging the object region images to obtain arranged images of an object type.

Specifically, the object region images are aggregated, such that the object region images are adjacently arranged to obtain the arranged images of the object type.

As an embodiment, a packing algorithm may be used to surround each object region image in a minimum bounding box containing all points of the corresponding object region image, and each object region image may be aggregated by moving the bounding box of corresponding object region image.

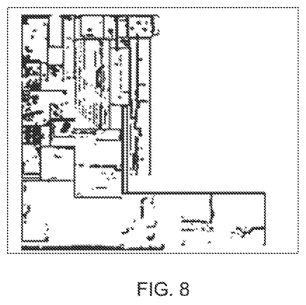

As shown in FIG. 7 which is a schematic diagram of an object bounding box in the embodiment of the present application, each object region image in the image layer of the object type is enclosed in the corresponding bounding box.

As shown in FIG. 8 which is a schematic diagram of arranged images of an object type in the embodiment of the present application, the bounding boxes of the object region images may be moved to arrange the object region images adjacently, so as to obtain the arranged images of the object type.

In the above implementation process, the object region images can be packed to a smaller space by adjacently arranging the object region images, thereby saving the space and reducing data redundancy.
S1032: arranging the around region images to obtain arranged images of a ground type.

Specifically, the ground region images can be aggregated using a Gaussian mixture model to obtain the arranged images of the ground type.

As an embodiment, the Gaussian mixture model may be used to perform non-linear division, and a graph corresponding to each Gaussian density function is used as one ground region image.

The Gaussian mixture model is described as the sum of M Gaussian density functions, and it can be expressed as:

p(v|wᵢ,μᵢ,Σᵢ)=Σᵢ₌₁^{M}wᵢg(v|μᵢ,Σᵢ) (6)
wherein V is a fitting vector formed by the elevation angle data, wᵢ and g(v|μᵢ,Σᵢ) are a weight and a density of each Gaussian density function respectively, and the Gaussian density function is:

$$g ( v \vert {μ}_{i} , {\sum }_{i} ) = \frac{1}{{( 2 π )}^{D / 2} {\vert {\sum }_{i} \vert}^{1 / 2}} exp \{ - \frac{1}{2} {( v - {μ}_{i} )}^{′} {\sum }_{i}^{- 1} ( v - {μ}_{i} ) \} \qquad ( 7 )$$

wherein μᵢ and Σᵢ are a mean value and a covariance matrix of the Gaussian density function, and D is a dimension of an input fitting variable.
wᵢ, μᵢ and Σᵢ(i=1, . . . M) are parameters of the Gaussian density function to be estimated.

The parameters of the Gaussian density function are estimated using maximum likelihood estimation by maximizing the likelihood of a given fitting data V={v₁ . . . v_{T}}, and the formula is as follows:

[symbol]

(v|wᵢ,μᵢ,Σᵢ)=Πₜ₌₁^{T}p(vₜ|wᵢ,μᵢ,Σᵢ) (8)
wherein T is a number of input fitting vectors.

The above parameters estimated with the maximum likelihood are obtained by performing iterations using the expectation maximization algorithm, so as to determine a closed form of formula (8). However, the expectation maximization algorithm converges to a local optimum due to initial conditions. Thus, an initial point affects the performance of the Gaussian mixture model in fitting data distribution. The Gaussian mixture model is initialized using a modified clustering algorithm (k-means++).
S1033: arranging the noise region images to obtain arranged images of a noise type.

The noise region images may be aggregated to arrange the noise region images, so as to obtain the arranged images of the noise type.

In the above implementation process, the region images of each type are adjacently arranged to obtain the arranged images of each type, and therefore, the region images are aggregated to reduce the occupied space of the images and thus reduce the redundancy.

Step 104: encoding each arranged image based on an encoding method correspondingly set for the type of the corresponding arranged image, so as to obtain encoded data of the laser radar point cloud.

Specifically, foil owing steps may be implemented when step 104 is performed:
S1041: encoding the arranged images of the noise type using binary differential encoding set for the arranged images of the noise type to obtain encoded data of the image layer of the noise type.

Specifically, the encoding method set for the arranged image of the noise type is binary differential encoding.

A process of encoding the arranged image of the noise type using binary differential encoding includes:
mapping noise coordinates in the arranged image of the noise type to the reference coordinate system, and then sequencing points according to the Morton code to minimize a difference between the adjacent points; then, in order to reduce encoding symbols and increase a probability of occurrence of repeated character strings, binarizing the difference between the adjacent points; and finally, compressing the binarized redundant difference using a lossless file encoder.

It should be noted that the reference coordinate system may be a Cartesian three-dimensional space coordinate system, or another three-dimensional space coordinate system, which is not limited herein.
S1042: encoding the arranged images of the object type using octree encoding set for the arranged images of the object type, so as to obtain encoded data of the image layer of the object type.

Specifically, the encoding method set for the arranged images of the object type is octree encoding.

As an embodiment, a point cloud in the arranged images of the object type is encoded using a context-based octree. First, the point cloud is divided using an implicit octree, that is, the point cloud in the arranged images of the object type after aggregation is divided according to a size of a minimum cuboid bounding box containing all points by a binary tree, a quadtree, an octree, and is represented by a mixed tree, wherein nodes containing points are represented as 1, and nodes not containing points are represented as 0. The current node is then encoded using neighbor occupancy as context.
S1043: encoding the arranged images of the around type using Gaussian differential encoding set for the arranged images of the ground type, so as to obtain encoded data of the image layer of the ground type.

Specifically, the encoding method set for the arranged images of the ground type is Gaussian differential encoding.

A process of encoding the arranged images of the ground type using Gaussian differential encoding is as follows.

First, points belonging to the same Gaussian density function are considered as a class. Second, a mean value of each Gaussian density function is taken as an elevation angle value θ corresponding to all the points in the class. A deflection angle φ of each point in the class is represented by linear fitting using linear fitting, i.e. parameters of the straight line and a corresponding abscissa value. Then, as for a Z value of each class, the encoding is performed on a difference of adjacent points. Next, the currently represented (θ, φ, z) is transposed into an original spatial coordinate system to obtain a reconstructed coordinate (x′, y′, z′). For achieving a lossless effect, a difference between the original coordinate (x, y, z) and the reconstructed coordinate (x′, y′, z′) for each point is encoded. Finally, when the arranged images of the ground type are encoded, elements required to be encoded are: the mean value of the Gaussian density function, the linear fitting parameters, the Z coordinate difference, and the difference between the original and reconstructed coordinates.

The encoded data of the laser radar point cloud may be obtained based on the encoded data of the image layer of the noise type, the encoded data of the image layer of the object type and the encoded data of the image layer of the ground type.

In the above implementation process, the arranged images of each type may be encoded to obtain the encoded data of the image layer of each type, such that the image layer of each type forms a data stream, thus facilitating data transmission.

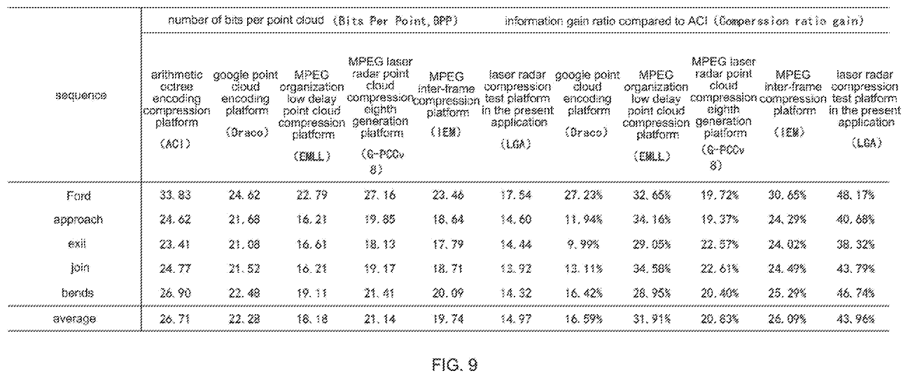

As an embodiment, the same radar point cloud is encoded using the point cloud encoding method in the present application and a current point cloud geometric compression platform to obtain the encoding result, and the encoding result is compared. The comparison result is shown in FIG. 9 which is a comparison diagram of an encoding result in the embodiment of the present application.

In FIG. 9, ACI is an arithmetic octree encoding compression platform, Draco is a google point cloud encoding platform, EMLL is an MPEG organization low delay point cloud compression platform, G-PCCv8 is an MPEG laser radar point cloud compression eighth generation platform, IEM is an MPEG inter-frame compression platform, and LGA is a laser radar compression test platform in the present application.

In the above, a sequence encoded by each platform may include Ford, Approach, Exit, Join and bends.

Average represents an average value of numbers of bits in the encoding of plural sequences by each platform.

Bits Per Point (BPP) represents a number of bits per point cloud, and Compression ratio gain represents an information gain rate compared to ACI.

From FIG. 9, the encoding method in the present application has an optimal compression performance, and compared with the similar compression platforms, the compression performance of the encoding method in the present application is improved by 16.59% to 43.96%.

In the above implementation process, image layer division is performed on the laser radar point cloud, so that the division of point clouds with different characteristics in the laser radar point cloud is realized, which further facilitates the determination of the region division method of the image layer of each type according to the characteristics of the point clouds. In addition, the corresponding image layer is subjected to region division according to the region division method of the image layer of each type, so that a set of region images of each type are obtained, facilitating the arrangement of the set of region images of each type, thus reducing the occupied space of the region image and the redundancy of image data storage; further, the encoding method for the image layer of each type is used to encode the corresponding arranged images, thereby realizing lossless encoding of the laser radar point cloud, and improving the compression performance of the laser radar point cloud.

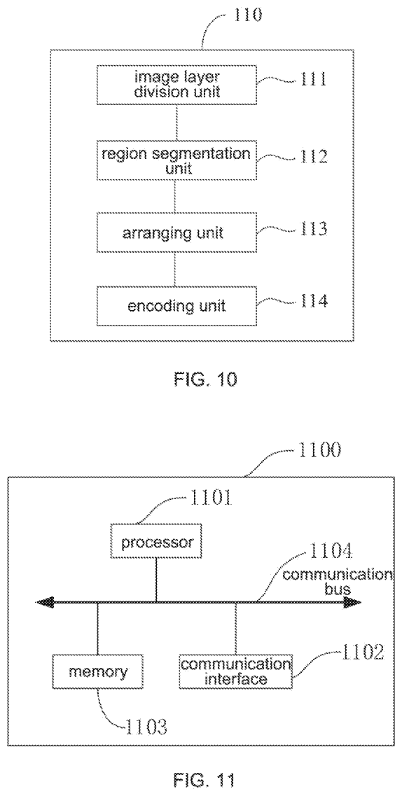

Reference is made to FIG. 10 which is a schematic structural diagram of a point cloud encoding apparatus according to an embodiment of the present application, and the apparatus 110 may include:
an image layer division unit 111, which may be configured to perform image layer division on a to-be-processed laser radar point cloud, so as to generate different types of image layers;
a region segmentation unit 112, which may be configured to perform region segmentation on each image layer using a region segmentation method correspondingly set for a type of the corresponding image layer, so as to obtain region images corresponding to each image layer;
an arranging unit 113, which may be configured to arrange the region images corresponding to each image layer to obtain arranged images corresponding to each image layer, such that every two adjacent region images in the arranged images have a connection point, wherein the type of each image layer is the same as that of the corresponding arranged images; and
an encoding unit 114, which may be configured to encode each arranged image based on an encoding method correspondingly set for the type of the corresponding arranged image, so as to obtain encoded data of the laser radar point cloud.

In an embodiment, the types of the image layers may include: a noise type, a ground type and an object type; and the image layer division unit 111 may be specifically configured to:
perform image layer division on the laser radar point cloud by filtering to obtain an image layer of a noise type and an image layer of a non-noise type; and
perform image layer division on the image layer of the non-noise type by ground extraction, so as to obtain an image layer of a ground type and an image layer of an object type.

In an embodiment, the region segmentation unit 112 may be specifically configured to:
perform object segmentation on the image layer of the object type to obtain object region images of an object type;
perform ground segmentation on the image layer of the ground type to obtain ground region images of a ground type; and
perform noise segmentation on the image layer of the noise type to obtain noise region images of a noise type.

In an embodiment, the region segmentation unit 112 may be specifically configured to:
perform coordinate system conversion on each coordinate point in the image layer of the object type based on a coordinate system of the image layer of the object type and a reference coordinate system, so as to obtain a mapped object image of the image layer of the object type in the reference coordinate system;
perform object segmentation on the mapped object image to obtain segmented object region images;
match the object region images with objects in the image layer of the object type respectively;
screen out an object characterized by successfully matched according to the matching result from the objects in the image layer of the object type; and
segment object region images corresponding to the screened object from the image layer of the object type.

In an embodiment, the region segmentation unit 112 may be specifically configured to:
perform coordinate conversion on each coordinate point in the image layer of the ground type based on a coordinate system of the image layer of the ground type and the reference coordinate system, so as to obtain elevation angle data of each coordinate in the image layer of the ground type in the reference coordinate system; and
perform Gaussian fitting on the elevation angle data of each of the coordinate points to obtain the ground region images of the ground type.

In an embodiment, the region segmentation unit 112 may be specifically configured to:
perform noise segmentation on noises in the image layer of the noise type to obtain each noise region image of the noise type.

In an embodiment, the arranging unit 113 may be specifically configured to:
arrange the object region images to obtain arranged images of an object type;
arrange the ground region images to obtain arranged images of a ground type; and
arrange the noise region images to obtain arranged images of a noise type.

In an embodiment, the encoding unit 114 may be specifically configured to:
encode the arranged images of the noise type using binary differential encoding set for the arranged images of the noise type, so as to obtain encoded data of the image layer of the noise type;
encode the arranged images of the object type using octree encoding set for the arranged images of the object type, so as to obtain encoded data of the image layer of the object type;
encode the arranged images of the ground type using Gaussian differential encoding set for the arranged images of the ground type to obtain encoded data of the image layer of the ground type; and
obtain the encoded data of the laser radar point cloud based on the encoded data of the image layer of the noise type, the encoded data of the image layer of the object type and the encoded data of the image layer of the ground type.

It should be noted that the apparatus 110 shown in FIG. 10 can implement the processes of the method in the embodiment of FIG. 1. Operations and/or functions of the units in the apparatus 110 are configured to realize the corresponding flows in the method embodiment in FIG. 1 respectively. Reference may be made specifically to the description of the above method embodiment, and a detailed description is omitted here as appropriate to avoid repetition.

Reference is made to FIG. 11 which is a schematic structural diagram of an electronic device provided in an embodiment of the present application, the electronic device 1100 shown in FIG. 11 may include: at least one processor 1101, e.g., CPU, at least one communication interface 1102, at least one memory 1103, and at least one communication bus 1104, wherein the communication bus 1104 is configured to enable direct connection and communication of these components, and wherein the communication interface 1102 of the device in the embodiment of the present application is configured to perform a signaling or data communication with other node devices. The memory 1103 may be a high-speed RAM or a non-volatile memory, such as at least one disk memory. The memory 1103 may optionally be at least one storage apparatus located remotely from the aforementioned processor. The memory 1103 stores computer-readable instructions, which when executed by the processor 1101, cause the electronic device to perform the method process shown in FIG. 1 described above.

An embodiment of the present application provides a computer-readable storage medium having a computer program stored thereon, wherein the computer program, when executed by a processor, implements the method process shown in FIG. 1.

The present application further provides a computer program product which, when run on a computer, causes the computer to perform the method shown in FIG. 1.

In several embodiments provided in the present application, it should be understood that the disclosed system and method may be implemented in other manners. The described system embodiment is only exemplary. For example, the division of system apparatus is only a logical function division and may be other division in actual implementation. For another example, a plurality of apparatuses or components may be combined or integrated into another system, or some features may be ignored or not performed.

In addition, the units described as separate parts may or may not be physically separate, and parts displayed as units may or may not be physical units, that is, may be located in one position, or may be distributed on a plurality of network units. A part or all of the units may be selected according to an actual need to achieve the objectives of the solutions in the embodiments.

The above description is only embodiments of the present application and is not intended to limit the protection scope of the present application, and various modifications and changes may be made to the present application by those skilled in the art. Any modification, equivalent replacement, or improvement made within the spirit and principle of the present application shall be included in the protection scope of the present application.

### INDUSTRIAL APPLICABILITY

The present application provides the point cloud encoding method and apparatus, the electronic device, the medium, and the program product. The method includes: performing image layer division on the to-be-processed laser radar point cloud to generate the different types of image layers; performing region segmentation on each image layer using the region segmentation method correspondingly set for the type of the corresponding image layer, so as to obtain the region images corresponding to each image layer; arranging the region images corresponding to each image layer to obtain the arranged images corresponding to each image layer; and encoding each arranged image based on the encoding method correspondingly set for the type of the corresponding arranged image to obtain the encoded data of the laser radar point cloud. Therefore, the compression performance may be improved when lossless encoding is performed on the laser radar point cloud.

Furthermore, it may be understood that the point cloud encoding method and apparatus, the electronic device, the medium, and the program product according to the present application are reproducible and may be used in various industrial applications. For example, the point cloud encoding method and apparatus, the electronic device, the medium, and the program product according to the present application may be used in the field of point cloud processing technologies.

What is claimed is:

1. A point cloud encoding method, comprising steps of:
performing image layer division on a to-be-processed laser radar point cloud to generate different types of image layers;
performing region segmentation on each image layer using a region segmentation method correspondingly set for a type of the corresponding image layer, so as to obtain region images corresponding to each image layer;
arranging the region images corresponding to each image layer to obtain arranged images corresponding to each image layer, such that every two adjacent region images in the arranged images have a connection point, wherein the type of each image layer is the same as that of the corresponding arranged images; and
encoding each arranged image based on an encoding method correspondingly set for the type of the corresponding arranged image, so as to obtain an encoded data of the laser radar point cloud.

2. The method according to claim 1, wherein the types of the image layers comprise: a noise type, a ground type and an object type, and the step of performing image layer division on a to-be-processed laser radar point cloud to generate different types of image layers comprises:
performing image layer division on the laser radar point cloud by a filtering processing, so as to obtain an image layer of a noise type and an image layer of a non-noise type; and
performing image layer division on the image layer of the non-noise type by a ground extraction to obtain an image layer of the ground type and an image layer of the object type.

3. The method according to claim 2, wherein the step of performing region segmentation on each image layer using a region segmentation method correspondingly set for a type of the corresponding image layer, so as to obtain region images corresponding to each image layer comprises steps of:
performing object segmentation on the image layer of the object type to obtain object region images of the object type;
performing ground segmentation on the image layer of the ground type to obtain ground region images of the ground type; and
performing noise segmentation on the image layer of the noise type to obtain noise region images of the noise type.

4. The method according to claim 3, wherein the step of performing object segmentation on the image layer of the object type to obtain object region images of the object type comprises steps of:
performing coordinate system conversion on coordinate points in the image layer of the object type based on a coordinate system of the image layer of the object type and a reference coordinate system, so as to obtain a mapped object image of the image layer of the object type in the reference coordinate system;
performing object segmentation on the mapped object image to obtain segmented object region images;
matching object region images with objects in the image layer of the object type respectively;
screening out a successfully matched object according to a matching result from the objects in the image layer of the object type; and
segmenting the object region images corresponding to the screened objects from the image layer of the object type.

5. The method according to claim 4, wherein the step of performing coordinate system conversion on coordinate points in the image layer of the object type based on a coordinate system of the image layer of the object type and a reference coordinate system, so as to obtain a mapped object image of the image layer of the object type in the reference coordinate system comprises a step of:
mapping coordinate points in the coordinate system of the image layer of the object type into the reference coordinate system using a preset resolution, so as to obtain the mapped object image of the image layer of the object type in the reference coordinate system.

6. The method according to claim 3, wherein the step of performing ground segmentation on the image layer of the ground type to obtain ground region images of the ground type comprises:
performing coordinate conversion on coordinate points in the image layer of the ground type based on a coordinate system of the image layer of the ground type and a reference coordinate system, so as to obtain elevation angle data of the respective coordinate points in the image layer of the ground type in the reference coordinate system; and
performing Gaussian fitting on the elevation angle data of each of the coordinate points to obtain the ground region images of the ground type.

7. The method according to claim 3, wherein the step of performing noise segmentation on the image layer of the noise type to obtain noise region images of the noise type comprises:
performing noise segmentation on noises in the image layer of the noise type to obtain each noise region image of the noise type.

8. The method according to claim 3, wherein the step of arranging the region images corresponding to each image layer to obtain arranged images corresponding to each image layer comprises:
arranging the object region images to obtain arranged images of the object type;
arranging the ground region images to obtain arranged images of the ground type; and
arranging the noise region images to obtain arranged images of the noise type.

9. The method according to claim 3, wherein the step of encoding each arranged image based on an encoding method correspondingly set for the type of the corresponding arranged image, so as to obtain an encoded data of the laser radar point cloud comprises:
encoding the arranged images of the noise type using a binary differential encoding set for the arranged images of the noise type, so as to obtain an encoded data of the image layer of the noise type;
encoding the arranged images of the object type using an octree encoding set for the arranged images of the object type, so as to obtain an encoded data of the image layer of the object type;
encoding the arranged images of the ground type using a Gaussian differential encoding set for the arranged images of the ground type to obtain an encoded data of the image layer of the ground type; and
obtaining the encoded data of the laser radar point cloud based on the encoded data of the image layer of the noise type, the encoded data of the image layer of the object type and the encoded data of the image layer of the ground type.

10. A point cloud encoding apparatus, comprising:
an image layer division unit, configured to perform image layer division on a to-be-processed laser radar point cloud to generate different types of image layers;
a region segmentation unit, configured to perform region segmentation on each image layer using a region segmentation method correspondingly set for a type of the corresponding image layer, so as to obtain region images corresponding to each image layer;
an arranging unit, configured to arrange the region images corresponding to each image layer to obtain arranged images corresponding to each image layer, such that every two adjacent region images in the arranged images have a connection point, wherein the type of each image layer is the same as that of the corresponding arranged images; and
an encoding unit, configured to encode each arranged image based on an encoding method correspondingly set for the type of the corresponding arranged image, so as to obtain an encoded data of the laser radar point cloud.

11. The apparatus according to claim 10, wherein the types of the image layers comprise: a noise type, a ground type and an object type, and the image layer division unit is specifically configured to:
perform image layer division on the laser radar point cloud by a filtering processing, so as to obtain an image layer of a noise type and an image layer of a non-noise type; and
perform image layer division on the image layer of the non-noise type by a ground extraction to obtain an image layer of the ground type and an image layer of the object type.

12. The apparatus according to claim 11, wherein the region segmentation unit is specifically configured to:
perform object segmentation on the image layer of the object type to obtain object region images of the object type;
perform ground segmentation on the image layer of the ground type to obtain ground region images of the ground type; and
perform noise segmentation on the image layer of the noise type to obtain noise region images of the noise type.

13. The apparatus according to claim 12, wherein the region segmentation unit is specifically configured to:
perform coordinate system conversion on coordinate points in the image layer of the object type based on a coordinate system of the image layer of the object type and a reference coordinate system, so as to obtain a mapped object image of the image layer of the object type in the reference coordinate system;
perform object segmentation on the mapped object image to obtain segmented object region images;
match object region images with objects in the image layer of the object type respectively;
screen out a successfully matched object according to a matching result from the objects in the image layer of the object type; and
segment the object region images corresponding to the screened objects fro the image layer of the object type,

14. The apparatus according to claim 12, wherein the region segmentation unit is specifically configured to:
perform coordinate conversion on coordinate points in the image layer of the ground type based on a coordinate system of the image layer of the ground type and a reference coordinate system, so as to obtain elevation angle data of the respective coordinate points in the image layer of the ground type in the reference coordinate system; and
perform Gaussian fitting on the elevation angle data of each of the coordinate points to obtain the ground region images of the ground type.

15. The apparatus according to claim 12, wherein the region segmentation unit is specifically configured to:
perform noise segmentation on noises in the image layer of the noise type to obtain each noise region image of the noise type.

16. The apparatus according to claim 12, wherein the arranging unit is specifically configured to:
arrange the object region images to obtain arranged images of the object type;
arrange the ground region images to obtain arranged images of the ground type; and
arrange the noise region images to obtain arranged images of the noise type.

17. The apparatus according to claim 16, wherein the encoding unit is specifically configured to:
encode the arranged images of the noise type using a binary differential encoding set for the arranged images of the noise type, so as to obtain an encoded data of the image layer of the noise type;
encode the arranged images of the object type using an octree encoding set for the arranged images of the object type to obtain encoded data of the image layer of the object type;
encode the arranged images of the ground type using a Gaussian differential encoding set for the arranged images of the ground type to obtain an encoded data of the image layer of the ground type; and
obtain the encoded data of the laser radar point cloud based on the encoded data of the image layer of the noise type, the encoded data of the image layer of the object type and the encoded data of the image layer of the ground type.

18. An electronic device, comprising:
a processor, a memory and a bus, wherein the processor is connected with the memory through the bus, and the memory stores computer-readable instructions, wherein the computer-readable instructions, when executed by the processor, are configured for implementing the method according to claim 1.

19. (canceled)

20. (canceled)

19. The method according to claim 4, wherein the step of performing ground segmentation on the image layer of the ground type to obtain ground region images of the ground type comprises:
performing coordinate conversion on coordinate points in the image layer of the ground type based on a coordinate system of the image layer of the ground type and a reference coordinate system, so as to obtain elevation angle data of the respective coordinate points in the image layer of the ground type in the reference coordinate system; and
performing Gaussian fitting on the elevation angle data of each of the coordinate points to obtain the ground region images of the ground type.

20. The method according to claim 5, wherein the step of performing ground segmentation on the image layer of the ground type to obtain ground region images of the ground type comprises:
performing coordinate conversion on coordinate points in the image layer of the ground type based on a coordinate system of the image layer of the ground type and a reference coordinate system, so as to obtain elevation angle data of the respective coordinate points in the image layer of the ground type in the reference coordinate system; and
performing Gaussian fitting on the elevation angle data of each of the coordinate points to obtain the ground region images of the ground type.
